(19) United States
(12) Patent Application Publication
(10) Pub. No.: US 2014/0372245 A1
(43) Pub. Date: Dec. 18, 2014

(54) DEALERS ELECTRONIC EXCHANGE

(71) Applicant: Kenneth Sherrill Woodcock, Wilmington, NC (US)

(72) Inventor: Kenneth Sherrill Woodcock, Wilmington, NC (US)

(21) Appl. No.: 13/950,840

(22) Filed: Jul. 25, 2013

Related U.S. Application Data
(60) Provisional application No. 61/834,547, filed on Jun. 13, 2013.

(51) Int. Cl. G06Q 30/06

(52) U.S. Cl. CPC G06Q 30/0611
USPC 705/26.4

(57) ABSTRACT

A dealer to dealer tool allows a dealer to post a car for sale with specific details, or search for a car with specific details, using an app or IVR system and thus untethered from computers, though a computer option is provided. A human operator response system is included as an alternative. The device requires any interested party to meet the minimum price, which may be hidden or posted. The device of the invention allows extra services such as dealer to dealer networking for advice, news, data updates, social purposes and more. If a vehicle does not change owners it is quickly timed out to a Hot List system, then a bulletin board, and then blacklisted until it has a new owner. A dealer signs up and enters a profile of vehicles and/or price ranges of interest, also listing other dealers they do not wish to work with.

### CROSS-REFERENCE TO RELATED APPLICATIONS

This application claims the priority date, benefit and incorporates by reference all materials originally presented in co-pending U.S. Provisional Application No. 61/834,547 in the name of the same inventor, Kenneth Sherril Woodcock, and filed Jun. 13, 2013.

### COPYRIGHT NOTICE

A portion of the disclosure of this patent document contains material which is subject to copyright protection by Kenneth Sherrill Woodcock. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### FIELD OF THE INVENTION

This invention relates generally to vehicle sales and specifically to electronic dealer to dealer vehicle sales.

### STATEMENT REGARDING FEDERALLY FUNDED RESEARCH

This invention was not made under contract with an agency of the US Government, nor by any agency of the US Government.

### BACKGROUND OF THE INVENTION

Vehicle sales constantly suffer from the problem of not having what a potential consumer buyer wants when the consumer shows up on the dealer's lot. The consumer may want a specific type of car or even a specific car down to details such as year, color, and optional equipment. For the dealer, it is frustrating knowing that such a car is probably available somewhere local, but there is simply not time to locate the desired vehicle while standing with the consumer out in a field of vehicles. Certainly given time a dealer might use the telephone and locate the vehicle, or the dealer might turn to various computer systems which can be used to locate cars, but in fact the consumer is unlikely to wait while the dealer returns to the office and begins a slow computer search.

Contra wise, sometimes the consumer has a car to trade-in but the dealer just does not wish to handle/inventory/purchase that particular vehicle. Again, given time the dealer can dispose of the car by telephone or computer system, but the consumer is unlikely to give the dealer time.

Both of these problems are exacerbated by the fact that most dealers have specific cars in which they deal. The cars the dealer handles may be only used, only a specific brand, only of a certain body style or perhaps only within a specific price band.

Computer assisted vehicle auctions are well known, however, the present invention does not teach an auction. One example of improving automobile auctions is taught by US Patent Application Pub. No. 2005/0256780 to Eldred, Nov. 17, 2005. That particular item merely shows that an auction house can improve bidding by locating dealers with under stock areas in their inventory. Berent et al, U.S. Pat. No. 6,006,201, Dec. 21, 1999, teaches another electronic auction system.

An example of known computer systems for locating automobiles for sale is found in US Patent App. Pub. No. 2004/0068442 to Ertle on Apr. 8, 2004. This item teaches a coordinating franchiser in a computer system, but does not teach many aspects of the present invention, such as use of smart phone apps, specified offers of interest and so on.

Bouwens et al in US Patent App. Pub No. 2009/0048942 of Feb. 19, 2009 teach a computer system having a database, but as is common in such systems, it is merely a database of cars, not a database such as might be used to assemble an extremely detailed description of a specific automobile.

Wolfe et al (U.S. Pat. No. 8,005,731, Aug. 23, 2011) at least shows purchase requests, but these requests are dissimilar to either the offers of interest or responses of the present invention.

These are merely exemplary of the patents which show various aspects of vehicle auctions or online inventory sharing.

It would be preferable to find a way for a dealer to use mobile computing devices to locate a vehicle or interest in a vehicle from among other trusted dealers.

It would further be preferable to provide a very large database of terminology regarding vehicles and details of those vehicles, including an audible method of handling such details by IVR (Interactive voice response, voice to text speech to text, or voice to voice, or other methods or combinations thereof), or by operator or transcription service.

It furthermore would be preferable to provide a social and professional networking system geared to the needs of vehicle dealers.

### SUMMARY OF THE INVENTION

### General Summary

The present invention does not teach an inventory sharing system, nor does it teach an auction system. Such systems are valuable but do not serve the same objectives as the present invention.

The present invention does teach a rapid response system (sometimes identified by the name “Dealer Hawk” herein). The rapid response system uses mobile devices to send and respond to interest in a particular vehicle. The rapid response system is also the gateway to a Hot List system, which in turn serves as a gateway to a bulletin board system.

Members of the system may include dealers of cars, trucks (light and heavy), motorcycles, boats, RV's, motor homes, airplanes and more.

The present invention teaches a dealer to dealer electronic system and method (or process) for facilitating the sale or purchase of cars between vehicle dealers. Parts of the system may be adapted to consumer sales as well.

In particular, the present invention teaches a method (or process) of dealer to dealer sales in which a first dealer puts out an offer of interest (not a contractual offer) and responses may come back promptly, in many situations, while the potential consumer is still test driving a car. The offer of interest goes only to other dealers who are part of the overall network and have specified through a “Profile Setup” (a set of predetermined questions) that they would be interested in that particular type of vehicle, and who the dealer has indicated (via either an opt-in list or a blacklist) that he is interested in dealing with. Other dealers who are interested in the car for sale or purchase may then respond through the system. These responses are then collected and presented to the first dealer. However, the first dealer may provide a hidden minimum bid (or in the case of a dealer seeking a purchase, a hidden maximum bid) and those responses which do not meet the hidden bid will not be presented to the dealer. In embodiments, the responding dealer may later see that the reserve has not been met by their own bid, by means of an automated response generated from the central software system.

Unlike an auction, the first dealer is not obligated to accept the highest bidder. The network may show not only all acceptable bids, but also “a dealer ratings” so that the dealer may choose to accept the bid of a better rated offeror rather than the highest/best bid/offer. The dealer rating is merely part of dealer profile data which might be made available in embodiments. Unlike most electronic systems, the sale is not concluded through the system either, rather, the dealers then contact one another and conclude the sale by other commercially-normal channels, while adhering to the network rules upon which they agreed at the time they enrolled. The network/module may display at least one option for the first dealer which allows a “one click” selection of the winning bid: the “one click” choice (not to be confused with “one click” shopping) will provide both dealers with the other one's contact data, provided by the network, so that the offline transaction can be initiated quickly after the use of the rapid response system.

The present system also does not merely carry an inventory of vehicles, rather, dealers are communicating via the system with the intent of handling a specific vehicle of particular and urgent interest.

In general, a quite short period of time (such as 24 hours, or in embodiments even less if practical) is used for the rapid response system, which becomes the gateway to the Hot List system/tool which uses a somewhat longer period of time (such as 7 days in embodiments) and in turn serves as a gateway to the Bulletin Board, which will have a much longer period of publication, such as 30 days or the like.

Thus, uniquely, the system allows dealers to have offers of interest out in very limited numbers, such as one vehicle at a time. Uniquely, the system offers a smartphone/tablet app so that dealers need not (but optionally may) use a computer system, live operator, transcription service or a combination of IVR and transcription service. Uniquely, the system requires vehicles to time out after 24 hours from the original broadcast using Dealer Hawk (the rapid response system) (or more accurately, the targeted narrowcast) of the vehicle. At this time a notice will be sent to the dealer which gives the dealer an opportunity to “roll over” his listing to a Hot List system for a period of 7 days. After the 7 days, on the Hot List system, the listing will be timed out and another notice will be sent to the offering dealer to give him an opportunity to now list the vehicle on a bulletin board for 30 of days. After the 30 day listing, on the bulletin board, has timed out a notice will be sent notifying the dealer that the listing has expired and this vehicle will be removed from the network.

In addition, the present system teaches a supporting environment which functions rather like a social network, however, unlike previous social networks or even professional networking services, this system is not merely social or person to person but rather also revolves around vehicle sales: discussions of vehicle changes and new models, bulletin-board systems for vehicles which have timed out of the system allowing dealer personnel to continue to view vehicles offered in order to increase income, resumes of sales staff who might be job hunting, classified ads, and industry related news and topics that will support the goal of increasing the vehicle sales of network members and their staff and listings of vehicles on the Hot List system and on the Bulletin Board

The invention is also a human network (similar to a business networking group) that has rules and regulations for its members to follow. The tools that are being patented such as the rapid response system (which may be termed “Dealer Hawk”) the Hot List system, the Bulletin Board and the Added Value Section are all for members use only. “Carmen's Lounge” will be available to all full members and their employees as well as members without dealership sponsorship who are given limited membership upon approval.

An example of the use of the system is provided for clarity.

A consumer, not a member of the system, approaches a dealership and begins automatically strolling about the cars parked on the dealership's normally quite large lot. A salesman approaches and asks if they can assist and after gaining a first advance of establishing personal interaction with the consumer then asks what the consumer is interested in.

Very often the dealer will instantly realize that they do not have exactly what the consumer wants, or that their inventory/stock is small enough that the consumer may walk, that is, depart, costing the dealer that valuable personal interaction and preventing a second advance to discussing a specific vehicle. This correlates instantly to lost profit, so the present system is designed to prevent that loss of profit by preventing the departure of the consumer due to lack of inventory.

In the past the dealer would have had to lure the reluctant consumer into their office and consult the computer inventory system to find the specified vehicle, but in all likelihood the vehicle being present somewhere else will merely cause the consumer to depart the first dealer's establishment or go to that other location: another dealer, if the consumer learns where the car is located.

Also, one of the main goals, advantages and aspects of the rapid response system part of the invention is to get a rapid response bid on the potential trade in while the potential consumer is test driving a car.

With the system of the present invention, the dealer removes their smartphone from their pocket or purse and with the mobile device in their hand they immediately enter into an “offer of interest” module, using a comprehensive database of options and characteristics (including software and modules enabling various different parts of the system), a description of the desired vehicle which is immediately narrowcast to members who have selected receiving information on vehicles of the type being queried (such as dealers who have selected a particular model or age of vehicle) or dealers who have not put any vehicle preference into their profile. Any responses which come back promptly in many situations, while the potential consumer is present or test driving a car will then allow the dealer to offer the vehicle to the consumer, for example, one technique might be to propose to the consumer, “I have found the vehicle”.

In addition, the Hot List system will allow the salesperson, for various reasons ie: convenience, windy conditions, the need for communication of extreme details and more to quickly inform a colleague (such as a dedicated “rapid response” expert”, an IT person, a colleague or a sales manager) at the dealership of the nature of the desired vehicle and then while the salesperson continues to interact with the consumer, the colleague quickly uses the rapid response system to find the desired vehicle or bid.

Note that for the purposes of the present invention a “mobile device” or cell phone may constitute a tablet computer, a phablet, a smart phone, a traditional mobile phone (flip phone), mobile computer and so on, and the invention may cover other computers, operator, transcription service and a combination of IVR and operator transcription and land lines as well.

### SUMMARY IN REFERENCE TO CLAIMS

It is therefore another aspect, advantage, objective and embodiment of the invention, in addition to those discussed previously, to provide an electronic system for use by a vehicle dealer with a mobile device connected to an electronic network and having vehicle details, comprising:

a server having a response module and a networking module programmed therein;

such dealer having available a first module on such mobile device, the first module in turn connecting to the server and to the response module;

such dealer using the first module to provide such details of such car to the response module;

the response module operatively connected to the networking module to narrowcast such details of such vehicle.

It is therefore another aspect, advantage, objective and embodiment of the invention to provide an electronic system for vehicle sales, for use by a second dealer having a second mobile device, further comprising:

the narrowcasting of such details comprising transmission of such details by the narrowcasting module to such second dealer by means of such second mobile device.

It is therefore another aspect, advantage, objective and embodiment of the invention to provide an electronic system for vehicle sales, further comprising:

a profile module allowing such dealer and such second dealer to individually set up and save to the server respective first and second profiles;

the second profile operative to notify such second dealer of such details only if such details match a selection choice made by such second dealer.

It is therefore another aspect, advantage, objective and embodiment of the invention to provide an electronic system for vehicle sales, further comprising:

wherein the first profile operative to notify such second dealer of such details only if such notification matches a selection choice made by such first dealer.

It is therefore another aspect, advantage, objective and embodiment of the invention to provide an electronic system for vehicle sales, wherein the response module further comprises:

a member selected from the group consisting of: interactive voice recognition (IVR) systems, an app based check-box and menu system, a server based system, and combinations thereof.

It is therefore another aspect, advantage, objective and embodiment of the invention to provide an electronic system for vehicle sales, for use by a first dealer and a second dealer having respective first and second mobile communication devices, the electronic system comprising:

a vehicle having specific characteristics associated therewith, including year of manufacture, manufacturer, mileage and condition;

a membership list including both such first and second dealers;

a server having an offer module, a response module, a tracking module, a rating module, a profile module, a database module and a narrowcast module programmed thereon;

the profile module having a first profile associated with such first dealer and a second profile associated with such second dealer; the profile including for each such dealer a range of characteristics of vehicles in general in which such dealer is interested, including for each such dealer profile at least one year of manufacture and at least one vehicle manufacturer;

the database module containing the characteristics of vehicles in general, including year of manufacture, manufacturer, mileage, condition and optional equipment;

the offer module operative to accept a first communication in the form of an offer of interest from such first dealer, the offer of interest expressing specific characteristics of the vehicle, a first price (if the first price is NOT hidden by the dealer, although in practice a hidden price may be more desirable), and an indication if such first dealer wishes to buy or sell the vehicle; the offer module further operative to access the database module and query such first dealer for answers regarding the characteristics of vehicles in general as found in the database module;

the narrowcast module filtering the offer of interest for characteristics of the vehicle compared to the characteristics of vehicles in general of the second profile of such second dealer, and if the offer of interest passes through the filter, transmitting to such second dealer the specific characteristics of the vehicle;

the response module allowing such second dealer to respond to such offer of interest, the response including a second price for the vehicle; the response module filtering the response for the second price compared to the first price and if the second price meets the first price the response passes through the filter and the response module transmits to such first dealer the response and second price.

the system having a simultaneous offer of interest limit for each such dealer, the offer of interest limit being a maximum number of offers of interest from each such dealer, usually one.

the system having a timeout period, the timeout period being the maximum amount of time which an offer of interest is allowed to remain system, after which it is automatically removed from the system;

the offer module further operative to receive all responses and to display them to such first dealer; the first dealer being able to freely choose any response and conclude a transaction for the first vehicle outside of the system;

the tracking module operative to retain offer of interest information about each such dealer in each such dealer's respective profile; the tracking module further operative to display to each such dealer statistics concerning outcomes of offers of interest made through the system;

the ratings module operative to accept and display to all dealers on the membership list ratings of a such first dealer made by such second dealer, such ratings including a rating for the speed of payment and a rating for honesty concerning condition of the vehicle.

It is therefore another aspect, advantage, objective and embodiment of the invention to provide an electronic system for facilitating the sale of vehicles, wherein such first mobile communication device further comprises a mobile computing device having non-volatile memory and selected from the group consisting of: smartphones, tablet computers, and combinations thereof, and wherein the system further comprises:

a client-side app programmed into such mobile computing device non-volatile memory, the client-side app operative to communicate with the server and the server modules.

It is therefore another aspect, advantage, objective and embodiment of the invention to provide an electronic system for facilitating the sale of vehicles, wherein such first mobile communication device further comprises a mobile computing device having non-volatile memory and selected from the group consisting of: laptop computers, desktop computers, and combinations thereof, and wherein the system further comprises:

a client-side computer application programmed into such mobile computing device non-volatile memory, the client side computer application operative to communicate with the server and server modules.

It is therefore another aspect, advantage, objective and embodiment of the invention to provide an electronic system for facilitating the sale of vehicles, wherein such mobile computing device further comprises a telephone; and wherein the offer and response modules further comprise:

one member selected from the group consisting of: an interactive voice response (IVR) system, a script prepared for a live operator, and combinations thereof.

It is therefore yet another aspect, advantage, objective and embodiment of the invention to provide an electronic system for facilitating the sale of vehicles, wherein the offer of interest may comprise one member selected from the group consisting of: interest in concluding a transaction to sell the vehicle, interest in concluding a transaction to buy the vehicle, and combinations thereof.

It is therefore yet another aspect, advantage, objective and embodiment of the invention to provide an electronic system for facilitating the sale of vehicles, wherein the response module allows such second dealer to make the response by a method selected from the group consisting of: response through a computer application, response through a mobile device app, response through a text message, response through an email, response by means of an interactive voice response system, transcription service, and combinations thereof;

and wherein the response module further comprises: a translation module operative to translate the selected method of the response into a desired response type, the desired response type indicated in the first profile of such first dealer, the desired response type also selected from the group consisting of: response through a computer application, response through a mobile device app, response through a text message, response through an email, response by means of an interactive voice response system, transcription service, and combinations thereof.

It is therefore yet another aspect, advantage, objective and embodiment of the invention to provide an electronic system for facilitating the sale of vehicles, wherein the respective first and second profiles of such first and second dealers each further comprises:

a sub-list of such dealers selected from the membership list, the sub-list of such dealers being one member selected from the group consisting of: such dealers to not send offers of interest to nor receive offers of interest from, such dealers to send offers of interest to and receive offers of interest from, and combinations thereof.

It is therefore yet another aspect, advantage, objective and embodiment of the invention to provide an electronic system for facilitating the sale of vehicles, wherein the simultaneous offer of interest limit is one.

It is therefore yet another aspect, advantage, objective and embodiment of the invention to provide an electronic system for facilitating the sale of vehicles, wherein the timeout period is 24 hours.

It is therefore yet another aspect, advantage, objective and embodiment of the invention to provide an electronic system for facilitating the sale of vehicles, further comprising:

a hotlist distributed to the membership list, the hotlist having the vehicle thereon after the vehicle has suffered timeout of an offer of interest for the vehicle.

the system having a second timeout period, the timeout period being the maximum amount of time which a vehicle is allowed to remain on the hotlist, after which it is automatically removed from the hotlist.

It is therefore yet another aspect, advantage, objective and embodiment of the invention to provide an electronic system for facilitating the sale of vehicles, wherein the condition of the vehicle further comprises:

a list of conditions of individual parts of the vehicle, the individual parts including portions of the vehicle exterior, portions of the vehicle interior, a vehicle dashboard, and a vehicle engine.

It is therefore yet another aspect, advantage, objective and embodiment of the invention to provide a method of facilitating the sale of a vehicle, the method comprising the steps of:

providing a server;

providing a mobile computing device app;

accessing via the app a database module on the server containing the characteristics of vehicles in general, including year of manufacture, manufacturer, mileage, and condition;

entering via the app and by reference to the database module a description of a first vehicle;

narrowcasting the description of the first vehicle to a second mobile computing device app;

responding via such second mobile computing device app to such description of the first vehicle;

compiling all the responses to such description of the first vehicle;

selecting a response and;

concluding a transaction for the first vehicle.

It is therefore yet another aspect, advantage, objective and embodiment of the invention to provide a method of facilitating the sale of a vehicle, further comprising:

prior to entering a description of the first vehicle, entering a profile, the profile including information about desired vehicle years, costs, manufacturers and makes,

and the step of narrowcasting further comprising only narrowcasting the description of the first vehicle if the description of the first vehicle meets the profile.

It is therefore yet another aspect, advantage, objective and embodiment of the invention to provide a method of facilitating the sale of a vehicle, further comprising:

entering a first transaction price with the description of the vehicle;

entering a second transaction price with the response;

and the step of compiling all responses to such description of the first vehicle further comprising removing the response if the second transaction price does not meet the first transaction price.

It is therefore yet another aspect, advantage, objective and embodiment of the invention to provide an electronic system for facilitating the sale of vehicles, further comprising:

a bulletin board accessible to the membership list, the bulletin board having the vehicle thereon after the vehicle has suffered timeout of the second timeout period for the vehicle on the hotlist;

the system having a third timeout period, the timeout period being the maximum amount of time which a vehicle is allowed to remain on the bulletin board, after which it is automatically removed from the bulletin board system;

wherein the second timeout period is 7 days and the third timeout period is 30 days.

### BRIEF DESCRIPTION OF THE DRAWINGS

FIG. 1 is a block diagram showing the system in the context of larger communication systems such as the telephone network and the internet.

FIG. 2 is a block diagram showing the system in simplified form.

FIG. 3 is a block diagram of alternative offering/database access modules.

FIG. 4 is a block diagram showing the system in greater detail.

FIG. 5 is a diagram showing alternative mobile computing devices.

FIG. 6 is a diagram showing flow of a response through a format translation module, whereby each dealer operates in their own favored communication mode.

FIG. 7 is a block diagram of a contextual embodiment of the invention showing other aspects than the immediate response system.

FIG. 8 is a diagram showing various details of a vehicle.

FIG. 9 is a flow chart showing steps of the method embodiment of the invention.

FIG. 10 is a table of profile questions.

FIG. 11 is a table of tiers of vehicle dealers.

FIG. 12 is a diagram showing vehicular parts of a dealer profile.

FIG. 13 is a diagram showing networking portions of a dealer profile.

FIG. 14 is a diagram showing a part of a script for an IVR system, though a similar script may be used by a human operator or a transcription embodiment of the invention.

FIG. 15 is an exemplary form such as used in the selling of a vehicle.

FIG. 16 is an exemplary series of forms such as used in an app embodiment of the application with a small screen.

FIG. 17 is a continuation of the forms of FIG. 16.

FIG. 18 is an example of a response form on a mobile computing device.

FIG. 19 is an example of a Hot List system form for submission.

FIG. 20 is an example of the system including the rapid response module, the Hot List module/system, the bulletin board aspect and the respective timeout periods thereof.

### INDEX TO REFERENCE NUMERALS

| | |
|---|---|
| First smart phone | 102 |
| First smart phone app | 104 |
| Second smart phone | 106 |
| Second smart phone app | 108 |
| Internet | 110 |
| Phone system | 112 |
| Vehicle | 114 |
| Server | 202 |
| Non-volatile memory | 204 |
| Networking module | 208 |
| Response module | 206 |
| Profile module | 210 |
| First profile | 212 |
| First profile details | 214 |
| Second profile | 216 |
| Second profile details | 218 |
| Vehicle | 220 |
| Detail (dent) | 222 |
| First smartphone/tablet | 224 |
| First app | 226 |
| Second smartphone/tablet | 228 |
| Second app | 230 |
| Landline/IVR | 302 |
| Computer/Application | 304 |
| Mobile computing device | 306 |
| App checklist | 308 |
| Operator/transcriber | 310 |
| Script | 312 |
| Server | 402 |
| Non-volatile memory | 404 |
| Membership list/membership module | 406 |
| Offer module | 408 |
| Vehicular term database | 410 |
| Narrowcast module | 412 |
| First price | 414 |
| Profile module | 416 |
| First profile | 418 |
| Second profile | 420 |
| First profile details | 422 |
| Sub-list of membership directory | 424 |
| Second profile details | 426 |
| Response module | 428 |
| Rating module | 430 |
| Tracking module | 432 |
| Simultaneous offer of interest limit | 434 |
| Timeout period | 436 |
| Translation module | 438 |
| Vehicle | 440 |
| Detail | 442 |
| First mobile computing device | 444 |
| First dealer | 446 |
| Second mobile computing device | 448 |
| Second dealer | 450 |
| Smartphone | 502 |
| App | 504 |
| Tablet | 506 |
| App | 508 |
| Mobile phone (not “smart”) | 510 |
| Landline phone | 512 |
| Computer | 514 |
| Application | 516 |
| Response | 602 |
| App response | 604 |
| Text response | 606 |
| Email response | 608 |
| IVR/human operator response | 610 |
| Translation per profile | 612 |
| First dealer | 614 |
| Electronic system for | 702 |
| facilitating sales of vehicles | |
| Other BBS associated therewith | 704 |
| Hotlist | 706 |
| Vehicle | 802 |
| Vehicle details | 804, 806, 808, 810, 812, 814, 816, |
| | 818 |
| Provide server | 902 |
| Provide app | 904 |
| Enter profile | 906 |
| Accessing database | 908 |
| Enter details | 910 |
| Price detail | 912 |
| Filter | 914 |
| Narrowcast | 916 |
| Respond | 918 |
| Compile responses | 920 |
| Select | 922 |
| Conclude transaction | 924 |
| outside of electronic system | |
| Rapid response system | 1002 |
| First timeout period (436) | 1004 |
| Hot List system | 1006 |
| Second timeout period | 1008 |
| Bulletin board system | 1010 |
| Third timeout period | 1012 |
| Blacklist | 1014 |

### DETAILED DESCRIPTION

The present invention teaches a rapid method of buying and selling cars, with the goal of providing consumers with the vehicles they desire while the consumer is still available, for example during a test drive. However, the present invention does NOT teach an inventory sharing system, nor does it teach an auction system. Such systems are valuable but do not serve the same objectives as the present invention. In fact the features of an inventory sharing system, which includes large numbers of cars from a dealer, would clog up the rapid response aspect of the present invention with data which would cause dealers to ignore the narrowcast messages of the present invention and thus inventory sharing is discouraged in the system of the present invention. On a different issue, the present system does not teach an auction either as the features of an auction would have other negative impacts on the system of the present invention, which is designed to be a rapid response vehicle transaction system.

The term “offer of interest” in the present application does NOT refer to a contractual offer, and the present system is not an auction. Nor is it a database of cars available in a dealer's inventory. The offer of interest indicates that a dealer wishes either to buy or to sell a car having the particular characteristics, indicates whether it is a buy or a sell interest being expressed, and a price which must be met for the system to transmit any offer back to the dealer. The term “details” or “characteristics” of a vehicle refers not just to make, model, year and options but also condition of various parts of the vehicle, any relevant information and so on. The term “narrowcast” refers to a broadcast of an offer of interest between members of the network, however, the broadcast will be dramatically narrowed by the filtering of offers of interest based upon the profiles of both the first dealer and every potential recipient.

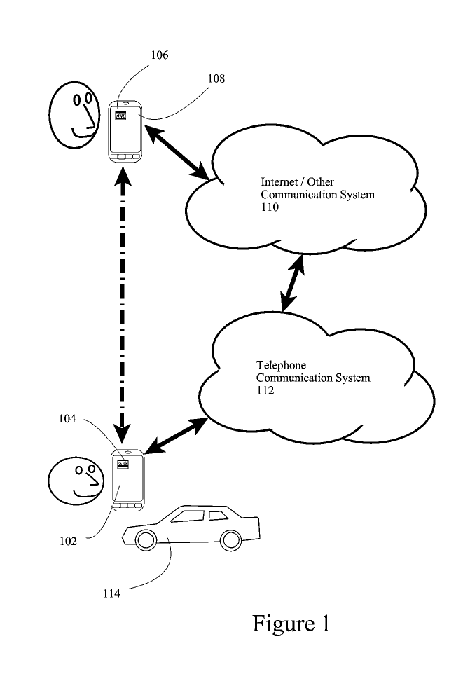

FIG. 1 is a block diagram showing the system in the context of larger communication systems such as the telephone network and the internet.

In the best mode now contemplated and presently preferred embodiment of the invention, first smart phone 102 has a first smart phone app 104 programmed thereon in non-volatile memory. A first automobile or vehicle dealer may access the app in a normal way as with any other app, by means of check boxes, text boxes, buttons, slides, scrolling controls and so on.

Second smart phone 106 has second smart phone app 108 and is owned by a different car dealer but is otherwise similar.

The smart phone apps 104 and 108 can access a server (not shown in FIG. 1) by various methods. The internet or other computer network 110 may serve this purpose, as most modern smartphones can use Wi-Fi, Blue tooth and other protocols. More commonly, phone system 112 which may offer 3G, 4G, or other data services may be used by the apps 104/108 to reach the server.

Car buyers normally care very much about the characteristics or options of the cars they buy. They usually have ideas about body style (sports car, pickup truck, SUV, minivan, economy, full-sized and so on and so forth), age or mileage of the vehicle (new, less than ten years old, less than 100,000 miles, etc.), cost of the vehicle, (under $30,000, under $5,000, etc.) and features they expect such as trim packages, accessories, options, color, seat material and more, not to mention make and model.

What is less well known is that dealers have similar requirements. Some dealers do not handle vehicles of a certain age, others only handle used vehicles, only certain brands and so on.

Vehicle 114 has certain characteristics or details. The details which a typical vehicle has determine whether it is saleable to a particular consumer or dealer.

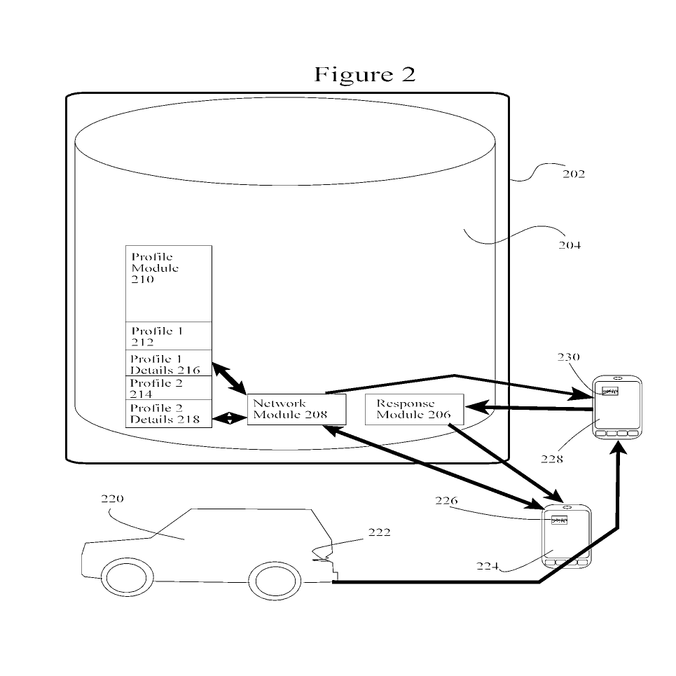

The present invention teaches that a system such as is depicted in FIG. 1 and in greater detail in FIGS. 2 through 19 can be used for this purpose.

FIG. 2 is a block diagram showing the system in simplified form, with the context of computer and telephone network systems omitted for clarity.

Server 202 has therein non-volatile memory 204 which has a number of modules programmed thereon. These modules and the remainder of the system cooperate to materially impact a vehicle by resulting in a change of ownership of the vehicle, not to mention exchanges of messages between dealers and so on.

Networking module 208 functions to “network” one dealer to another: it provides communication, social interaction; value added features such as education and news and valuation, and more. In particular, the networking module allows the exchange of offers of interest in a particular automobile and responses thereto. In this simplified embodiment, the networking module 208 includes the function of assisting the dealer to put together the offer of interest, and further includes the large database of information about car characteristics/details.

Response module 206 allows another dealer interested in the vehicle sale or purchase to respond. The response will be transmitted, however, only if the price meets the price detail for the car of interest. In the case of a second dealer who wishes to purchase the vehicle, “meeting” the price means equaling or exceeding the asking price, while in the case of a dealer who wishes to sell the vehicle requested, “meeting” the price means equaling or succeeding the price requested. The system can in alternative embodiments be arranged so that the asking price is set by whichever dealer is the seller, regardless of whether the seller is the first (offer of interest) dealer or the second (response) dealer. Note that in the preferred embodiment the price is NOT posted, rather, the minimum or maximum price (respectively for selling or buying by the first dealer) is HIDDEN. Only in alternative embodiments is the price posted.

Profile module 210 allows dealers to indicate to the system their own contact information, nature of their business and especially what sorts of vehicles they are interested in. Any type of feature may be used in the dealer profile: a first dealer profile 212 can indicate that they handle only a certain brand of car, a certain body style, age, price range, mileage, options, and condition and so on. For example, a dealer could indicate with first profile details 214 that they handle any Ford product, but that they refuse to handle any vehicle lacking air conditioning. Or a dealer profile could indicate that the dealer handles only cars having a price between $5,000 and $15,000, indicating that they handle used vehicles but not elderly used vehicles.

Second profile 216 and second profile details 218 will contain similar details for a second dealer. The ability of dealers to filter out vehicles they are not interested in is vital to the success of the system as it is anticipated that dealers will normally use the system on mobile computing devices such as very small computers, tablet computers and smart phones. If a dealer's smart phone becomes inundated with vehicles which are not of interest, the dealer will cease to examine incoming offers of interest in a timely manner. Thus, dealer profiling of the vehicles of interest is very important to the system, not just dealer satisfaction.

In addition, the dealer can set and reset in the initial profile and at later times the number of incoming transactions to be received before the responses are divided into batches. For example, a dealer might feel that 10 offers at a time is optimal and after reviewing these ten offers the dealer may hit “save” on for example 2 of the first 10, then she or he may hit “reset” or “next page” or the like and receive the next group of ten, and perhaps save some, until all offers have been made available. Then the dealer can returned to the saved offers and begin contacting those dealers.

Vehicle 220 will have details such as listed above, in this particular case detail 222, a dent. The dent has a location on the vehicle, a size, an extent, a description of any vehicle components impacted, broken or damaged by the dent and so on.

First smartphone/tablet 224 has thereon first app 226 while second smartphone/tablet 228

has thereon second app 230. The app functions to communicate operatively with the server 202 and the various modules thereof.

For even speed and convenience, the salesperson might quickly inform a coworker (such as a dedicated “rapid response” expert, a fellow sales professional, IT specialist or a sales manager) of the desired vehicle and then while the salesperson continues a test drive or have other discussions with the consumer, the coworker uses the rapid response system to quickly and easily find the consumer's choice of vehicle or for quickly and easily determining the salability of the consumer's trade-in.

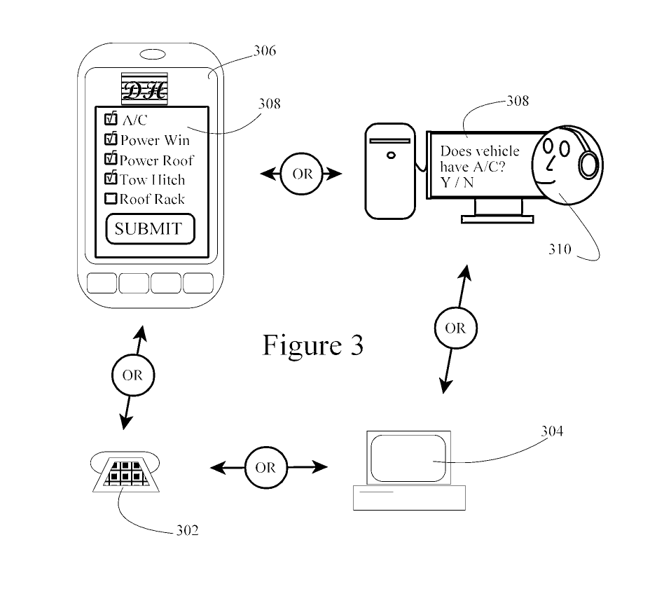

FIG. 3 is a block diagram of alternative offering modules. It will be appreciated that the system can advantageously present to a dealer wishing to make an offer a range of vehicular detail terms. All of the details/characteristics described previously, such as type and extent of wear or damage to a given portion of the vehicle, options and so on can be represented in the database. Thus the offering system may help the dealer put together the offer.

This can be done in several modes. The modes include, but are not limited to: an interactive voice response system (IVR) may be used, for example with any telephone/IVR 302. The database access may occur by means of a local or server based or cloud based computer application 304, for example by accessing a website. Mobile computing device 306 may also have access to the database, for example by means of app checklist 308, which checklist will have options presented based upon previous responses. That is, an initial entry of “2010 GM” products will then lead to options for various GM products available new in 2010, while omitting products of other automakers and GM products not made new in 2010.

Operator/transcriber 310 equipped with script 312 may also provide a means of putting together offers for dealers wishing to make offers of interest and thus needing access to a complete database of vehicle characteristics. It is possible that a combination of operator and IVR systems might be used, for example, 90% of questions might go to the IVR but it might perhaps be discovered that 10% of questions are consistently misunderstood and so get routed to a transcription service.

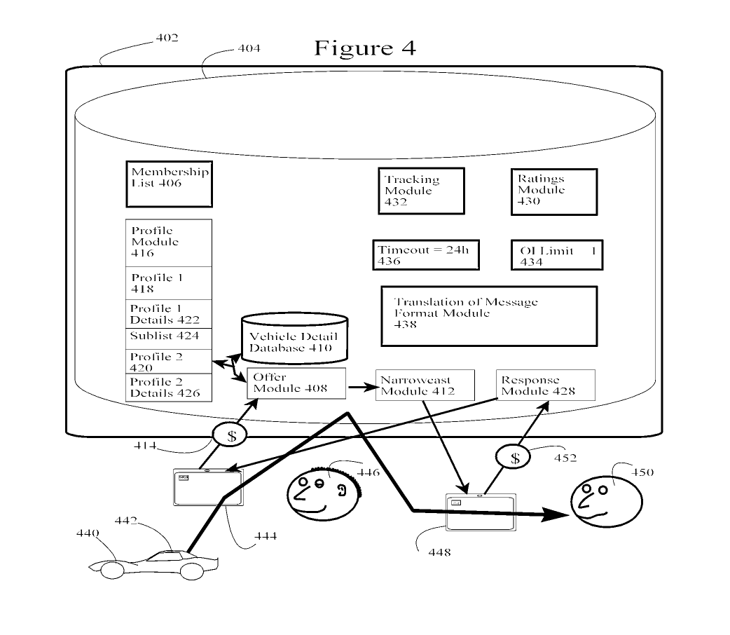

FIG. 4 is a block diagram showing the system in greater detail. In a preferred embodiment and best mode now contemplated for carrying out the invention, server 402

has thereon Non-volatile memory 404 having programmed thereon the diverse functions and modules of the system.

It is worth noting that “module” as defined herein can represent a functionality of the system not actually present as a standalone computer programming module. The module may be combined with other modules, divided up into different parts and so on.

Membership list/membership module 406 maintains a list of dealers who have signed up or joined or bought the system of the invention. This list is the largest possible group of dealers to which any offer of interest might be sent, although in practice, sub-lists and filtering by profile will reduce this greatly. The member can select to send offers of interest to franchised dealers or dealers that have set their profile of interest in particular vehicles.

Offer module 408 assists the dealer wishing to create an offer of interest. While it asks certain basic questions of the dealer, most importantly it helps the dealer to access the vehicular term database 410.

The vehicular term database 410 is extremely important to keeping costs of the system low. The vehicular term database 410 may be accessed, as previously discussed in relation to FIG. 3, by means of computer application, mobile device apps, or an IVR.

The database may have grammar files, and importantly, it may tune these files further to accommodate phonetic variations. With the addition of entry of VIN by a dealer and the use of a tool such as VINSCAN™ vehicle identification number scan ap/service, or another similar service the database may allow access to some fairly detailed information, albeit at the cost of increasing database size. This database size will vary then, since it may contain associated information about numerous types of vehicles, such as the fairly trivial information that a 1988 Cadillac Sedan DeVille may have an automatic light sensitive headlight feature, or the very basic information that a 1996 Ford Windstar minivan may have a 3.0 or 3.8 liter V-6 engine. It may contain the list of body parts a vehicle has (for example, that a Jeep Freedom will have a rear hatch) and the types of damage which each part might suffer from.

Thus the automatic speech recognition feature (ASR) will be the preferred mode of use for rapid responses/replies not precise details, however, for practical reasons other methods of response are included. For example, ASR systems generally do not work when the speaker is standing in wind. Thus the system might prompt the user: “What brand is the vehicle?” The user might respond “Ford” under optimal conditions, however, while for IVR purposes, the database may be audible, it is possible that it may as well need to be textual. Thus, a dealer who makes a call to the system with a mobile telephone in the wind, or is using a computer, etc., might quickly pass through a list of options offered by audio response such as: “I CANNOT RECOGNIZE YOUR RESPONSE, TRY AGAIN” and after the third failed attempt the system can say try again later or in preferred embodiments, pass the call to a human operator. It is important to carefully distinguish between the mixed IVR and transcription possibilities of the system.

Examples of prompts might include: “Press one if the vehicle is the LX trim line. Press two if the vehicle is the SX trim line. Press three if the vehicle is the EX trim line. Press four if the vehicle is the Eddie Bauer trim line.” However, this is not preferable because the amount of data needed to provide this thorough amount of choices would be detrimental to the speed of the system with the processing speed of present technology, however according to Moore's Law it will be within the scope of the invention within the next decade. (It is estimated that such a database, when complete, may be comfortably small and easy to provide and manage. However, the database might with technologies now known or later developed include challenging embodiments, or perhaps once the technology develops and allows greater accuracy, and thus might contain in excess of 30,000+distinct terms, which number might be multiplied in order to account for regional accents or even additional languages such as Spanish.)

First price 414 is a useful part of the system. In one preferred embodiment and best mode now contemplated, the system will automatically filter out any responses which fail to meet first price 414. This will prevent a dealer from seeing offers that they don't wish to see.

Narrowcast module 412 will filter the offer of interest, based upon the profile module 416 having therein first profile 418 (of the offer of interest dealer or first dealer) and second profile 420 (of a potential response dealer or second dealer). First profile details 422 might include an opt-in list of dealers he wishes to have his offers of interest sent to, or it might contain a blacklist of dealers to whom he never wants his offers of interest sent. It might contain a geographic limitation such as only dealers within a tri-state area, a single state, a region, 50 miles radius, the township and so on. This will take the form of a sub-list of membership directory 424. Thus, the dealer's own profile may filter out large numbers of other dealers before the transmission of the offer of interest.

Second profile details 426 may indicate types of cars that dealer handles, and again might contain a list of dealers from whom never to accept offers of interest. Thus narrowcast module 412 may filter out offers of interest based upon the potential recipients as well.

Finally, those dealers in the matching set will receive the offer of interest sent by the narrowcast module 412, and it is for this reason that the broadcast of the offers of interest is referred to as a “narrowcast”.

Response module 428 on the other hand can be somewhat simpler, as it essentially asks for a yes or no response and a second suggested price, and may or may not place the two dealers into direct communication for a transaction carried out outside the system.

Rating module 430 is important in allowing dealers to rate those they actually carry out business with, so that a dealer will begin to develop a positive reputation within the social system and this reputation will be useful to other dealers, as well as causing dealers to be scrupulous in their dealings.

Tracking module 432 allows a dealer to track each individual transaction (for example with an individual assigned ID number for the transaction) as well as to provide analytics so that a dealer may see how the system is profiting them, what they can improve, what vehicles they are buying and selling and so on.

Simultaneous offer of interest limit 434 is a limit, preferably ONE for the rapid response system, which represents the maximum number of vehicles, or rather offers of interest, which a dealer may have in the system at any one time. This number is preferably low so as to maintain interest in the system: if dealers begin to “spam” the system with numerous cars, the system will become irritating to other dealers. In addition, the system is NOT an inventory sharing system: no component of the system will be a full inventory sharing system.

Timeout period 436 is a period of time before an offer of interest times out and is removed from the system, preferably quite short. 24 hours is presently preferred, (however, it is at least theoretically possible that longer time may be used), and much shorter times may be used if demand for the system supports successful transfer of vehicles in shorter times. Thus the timeout periods of the system may vary depending on circumstances, dealer input and other factors.

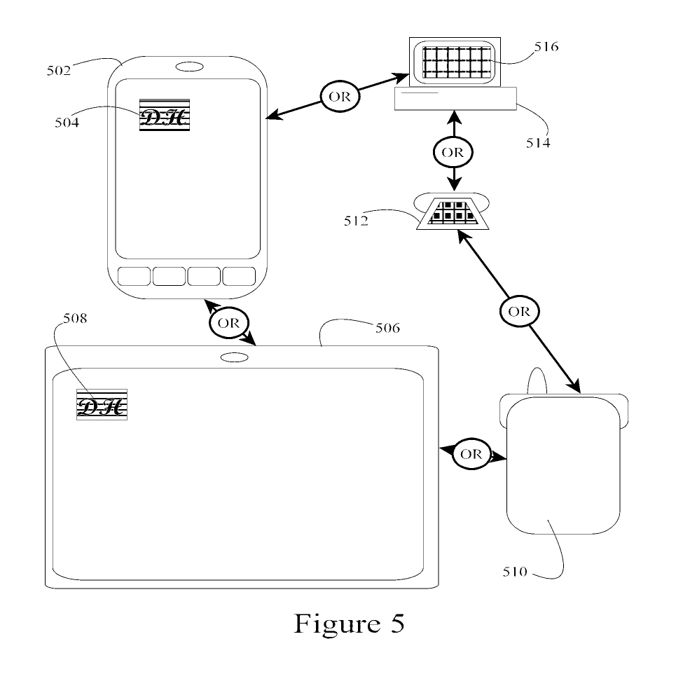

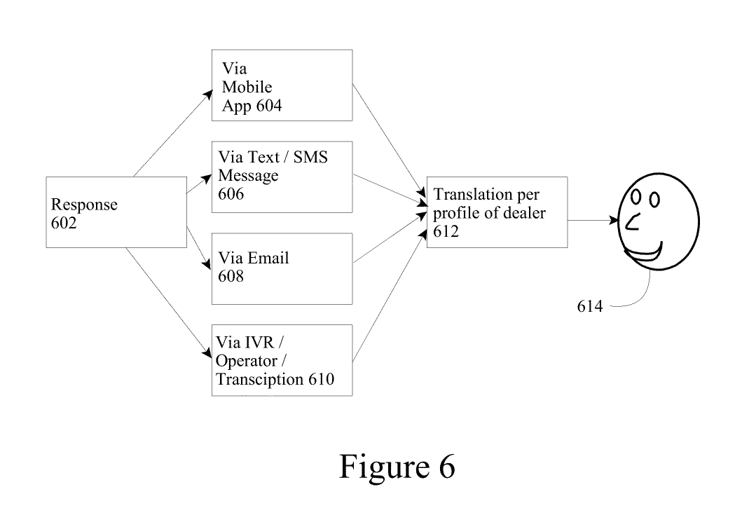

Translation module 438 is very important and will be discussed further in reference to FIGS. 5 and 6.

Vehicle 440, in this case a sports car, may have detail 442 such as a sun-roof. The vehicle will be transacted by the method of the system, changing ownership

First mobile computing device 444 belonging to first dealer 446 may be a tablet, a phablet, a mobile telephone, smartphone, a personal computer or the like. In general, it is anticipated that smart phones and tablets will be most useful to dealers, as most dealers carry either a smart phone or tablet in any case. Second mobile computing device 448 belonging to second dealer 450 may be similar.

If the dealer profiles are set to allow this, then the initial narrowcast of the offer of interest can in fact be sent to all forms of devices listed and similar devices now known or later developed.

FIG. 5 is a diagram showing alternative mobile computing devices. Smartphone 502 may communicate to other dealers by means of the system using app 504, as tablet computer 506 (for example a Samsung Tab or iPad or the like) may do so using app 508.

Mobile phone (not “smart”) 510 may communicate with the system using a transcription service, an IVR system, or by text message or SMS message, as may landline phone 512 (although the latter two options are unlikely or not preferable at this time).

Finally computer 514 may communicate through the system by means of application 516, which may be a web based application, a local application or a combination or other application type. Email is one obvious example of this.

All of these modes of communication carry a risk of causing inconvenience to the first dealer: she or he might seemingly be expected to check an endless assortment of modes of communication. Thus the translation module 438 makes the system work in a brisk and easy manner.

FIG. 6 is a diagram showing flow of a response through a format translation module, whereby each dealer operates in their own favored communication mode.

Thus response 602 may be made in several ways: an app response 604, a text response 606, an email response 608 or even a verbal IVR/human operator/transcription service response 610.

However, one detail 422 in first profile 418 of the first dealer 446 may be that they want responses via the app. Thus, the translation module 438 will then translate (or more accurately reformat) per profile 612 and transmit the response back to first dealer 614 in the format desired by the first dealer.

Obviously in alternative embodiments, this process can be used for the original offer of interest and it can be translated to the format desired by the second dealer.

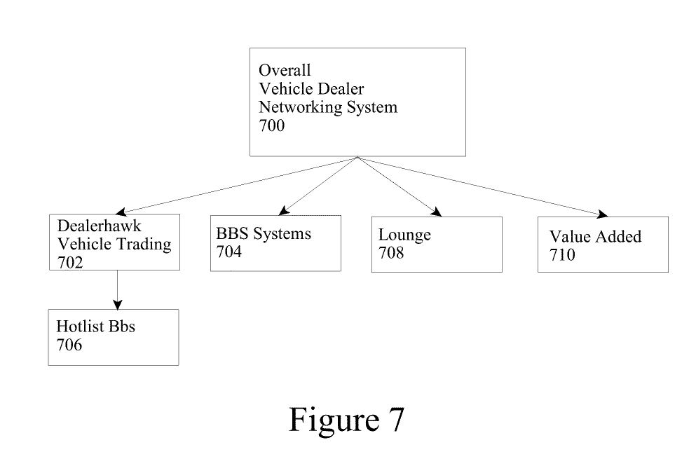

FIG. 7 is a block diagram of a contextual embodiment of the invention showing other aspects than the immediate response system.

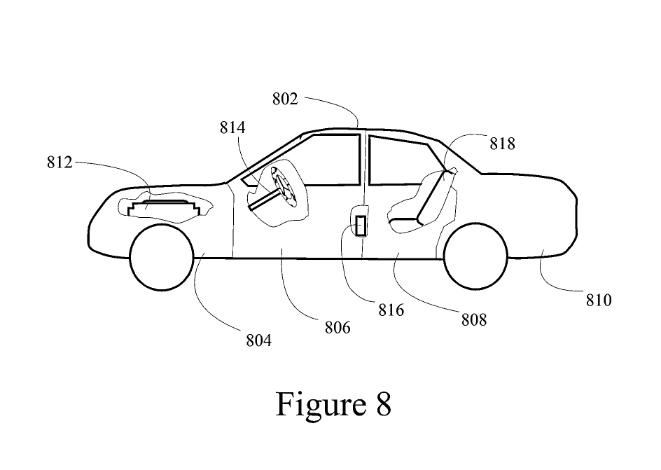

Electronic system for facilitating sales of vehicles 702 is as discussed previously in regard to FIGS. 1 through 6, and again with regard to FIG. 8 et seq.

Other features associated therewith 704 may include a hotlist 706, Carmen's lounge 708, a list of breaking updates and news items of interest to full members, their employees and limited members 710 and so on. It is anticipated that such a lounge might be a place for employees of dealerships to virtually congregate during lunch breaks, smoking breaks, and the like for social discussions, job hunting, gossip, viewing of advertisements, recall information, pictures of new models, a general social and news center and so on. Also a visitor might view, with permission, listed vehicles, thus enhancing potential income.

This aspect might evolve into an online car magazine supplement to the rest of the system, within the scope of the invention.

FIG. 8 is a diagram showing various details of a vehicle.

Obviously, if a dealer wishes to describe the overall condition of a vehicle as a single quality the dealer may do so. However one optional variation may be to describe the vehicle in terms of condition. Members might be trained by the IVR system to use a standardized jargon for condition.

For example, the system may contain terminologies that will train members to respond with the same jargon, for example, knat speck, sand speck, bb-sized paint chip, marble-sized ding, golf-ball dent, peach dent, orange dent, tennis ball dent, baseball dent, softball dent and so on.

Vehicle 802 may have details of damage or condition relevant to numerous parts of the vehicle such as front left fender detail 804, front left door detail 806, rear left door detail 808, rear left fender detail 810, engine detail 812, dashboard detail 814 and even plate detail 816 regarding the car's information sticker on the driver's door, as well as more for many other parts of the car: interior rear seat detail 818.

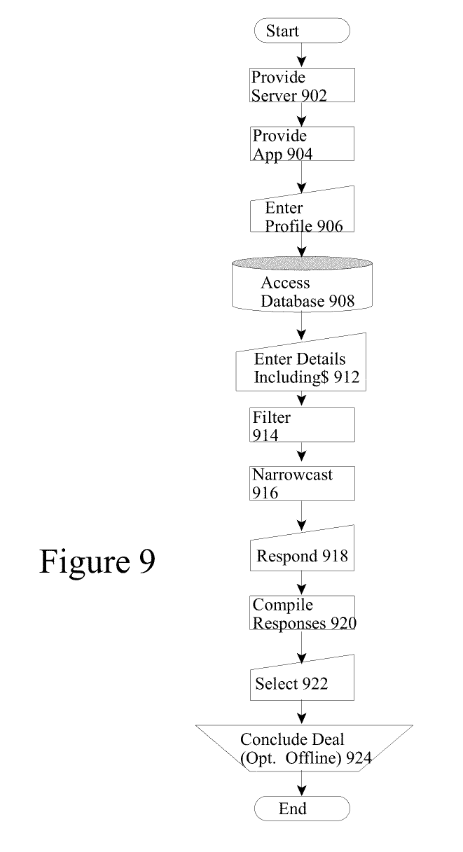

FIG. 9 is a flow chart showing steps of the method embodiment of the invention.

In use the first step is to provide server 902, and provide app 904 follows.

Enter profile 906 occurs individually as each dealer signs up for the service. Obviously dealers may update the profile at later times, but for a typical individual transaction that may not be necessary.

Accessing database 908 and entry of details 910 occurs at the time of creation of an offer of interest, optionally but not always including price detail 912.

Filtering 914 then determines to whom the offer of interest will be sent by narrowcast 916, the transmission or broadcast of the offer of interest.

Responding 918 is the indication by the second dealer of their interest in the system.

Compile responses 920 may occur when multiple responses come in before the first dealer can check them, obviously in embodiments the responses may come back one at a time if the dealer is available to receive them.

Selecting a response 922 is one significant difference between the invention and an auction: in an auction, the high bidder must be allowed to win the vehicle, but in the present system a dealer can select whatever offer they choose.

Conclude transaction outside of electronic system 924 indicates that the system may be used for the transaction but the system may also be used in order to facilitate the transaction by the transmission of the numerous decisions of different dealers to one another.

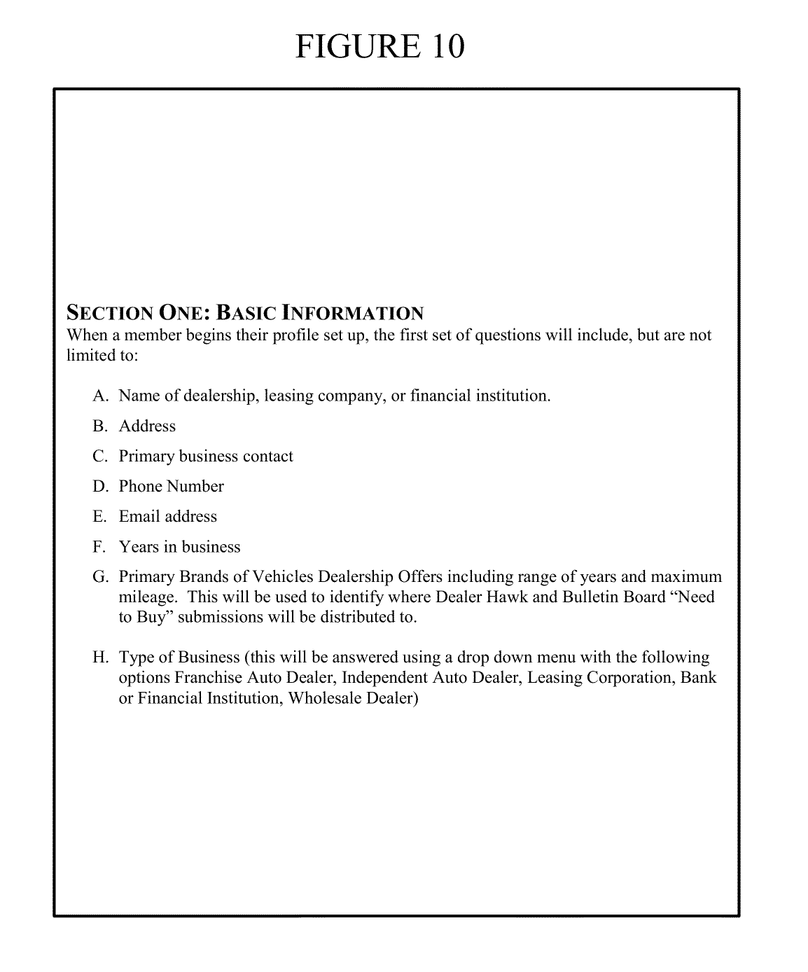

FIG. 10 is a table of profile questions. It may be seen that the dealer will be asked for basic contact information, years in business, primary brands dealt, etc.

The dealer profile will vary from dealer to dealer as each dealer signs up with the system (or alters their profile at a later date) and selects the important criteria they will have for the system to recognize when sending offers of interest. This is an important module and aspect of the overall interlocking systems of the invention.

For example, it is possible that the overwhelming majority of dealers will input at least one price range for buying, or selling, or wholesaling of vehicles with other dealers. For example a dealer might indicate in his or her profile that they are interested only in vehicles with a wholesale price from $5,000 to $20,000.

In addition or in alternative, the dealer may provide in their profile an indication of vehicle makes/brands they wish to deal with (GM, Ford, Chrysler but not Mercedes, Opal, Jaguar which they might blacklist). They may put in types of vehicles in addition or in alternative, such as four-wheel drive vehicles, motorcycles, RVs, etc. Age may be a criteria, etc.

These selections and more can be inclusive, or can be blacklists, etc.

One final important aspect of the profile mentioned earlier is the ability to select or deselect specific dealers with which to work.

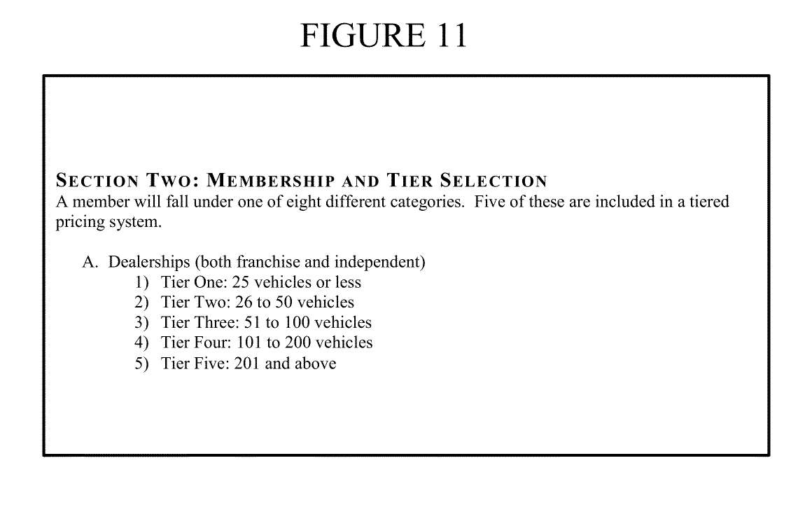

FIG. 11 is a table of tiers of vehicle dealers. Basic monthly membership fees may be set by tiers depending on the average number of vehicles kept on the premise.

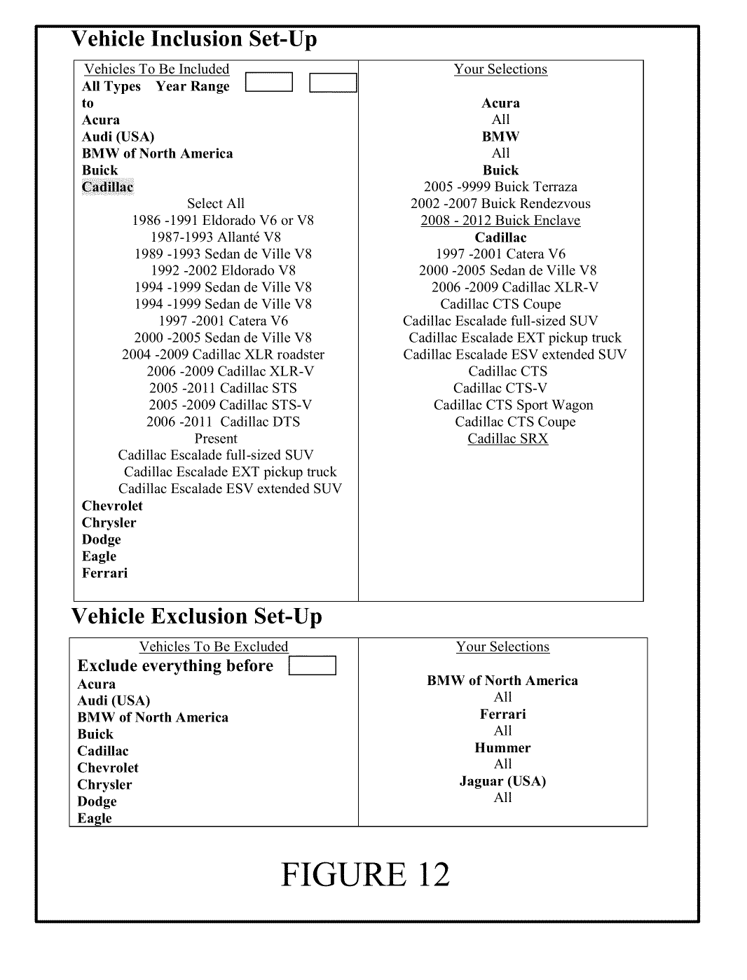

FIG. 12 is a diagram showing vehicular parts of a dealer profile. “Vehicle Inclusion Set-Up” is demonstrated in this figure as a year range, a selection of models, and so on. “Vehicle Exclusion Set-Up” on the other hand functions to exclude vehicles of a certain age, brand, characteristic (“exterior damage, no A/C, etc.”) and the like.

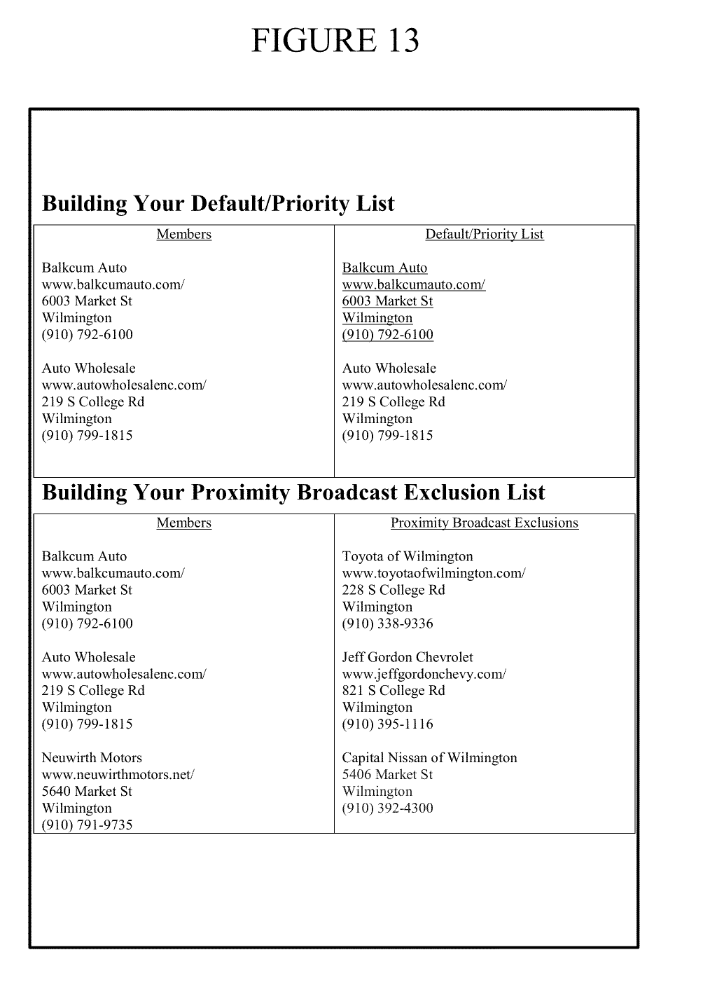

FIG. 13 is a diagram showing networking portions of a dealer profile. The dealer may both opt-in other dealers, blacklist other dealers and can even indicate higher priority dealers.

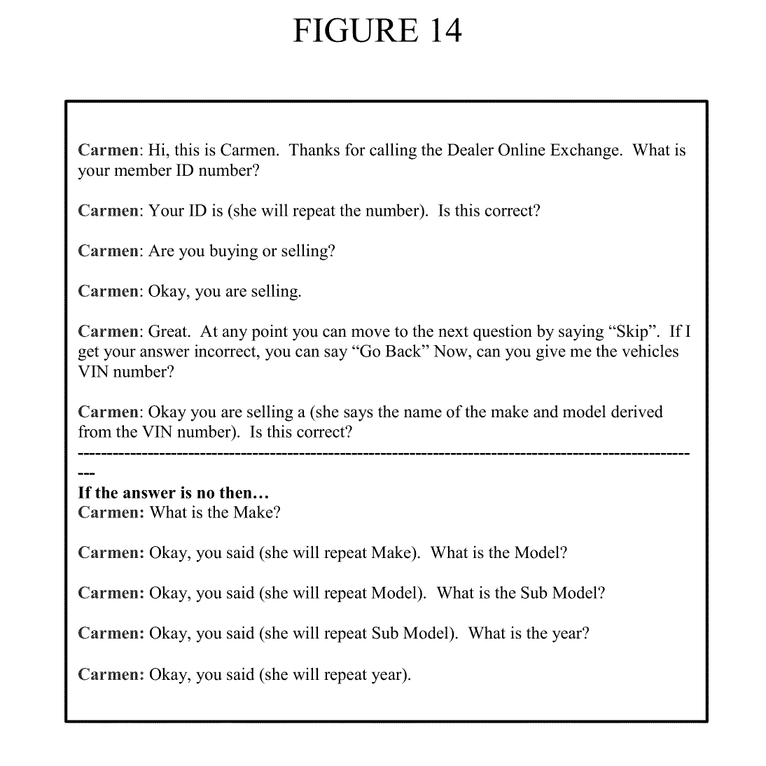

FIG. 14 is a diagram showing a part of a script for an IVR (voice to text) system, though a similar script may be used by a human operator or a transcription embodiment of the invention. A human operator may use such a script in order to navigate the many possible configurations of vehicles, options and conditions which might exist.

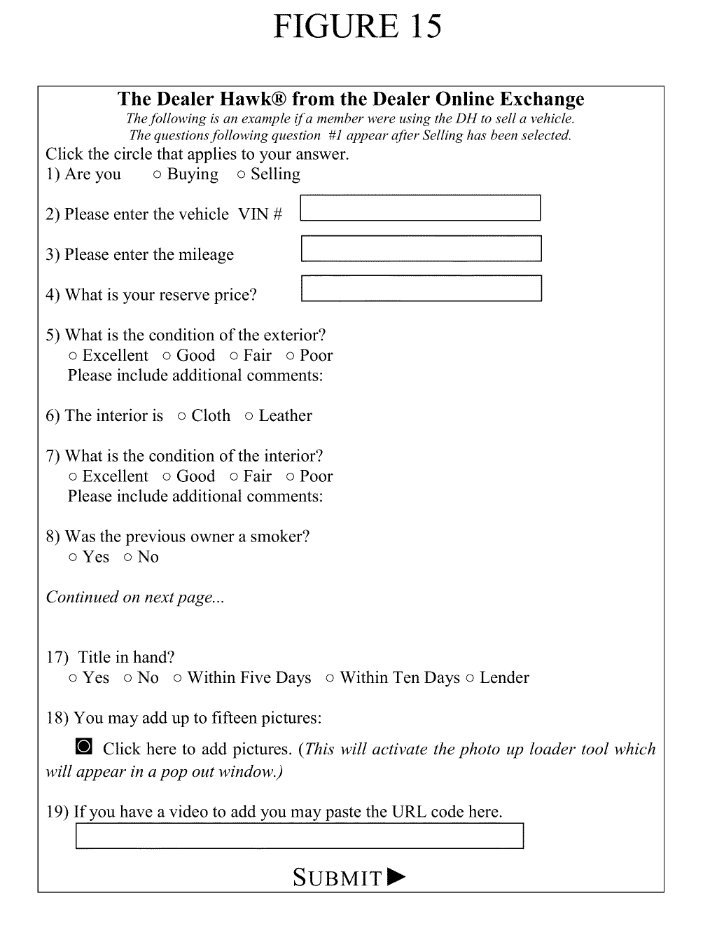

FIG. 15 is an exemplary form such as used in the selling of a vehicle. It may be seen that VIN# is used, thus ensuring that the vehicle being indicated is the same vehicle actually delivered, mileage and so on are present.

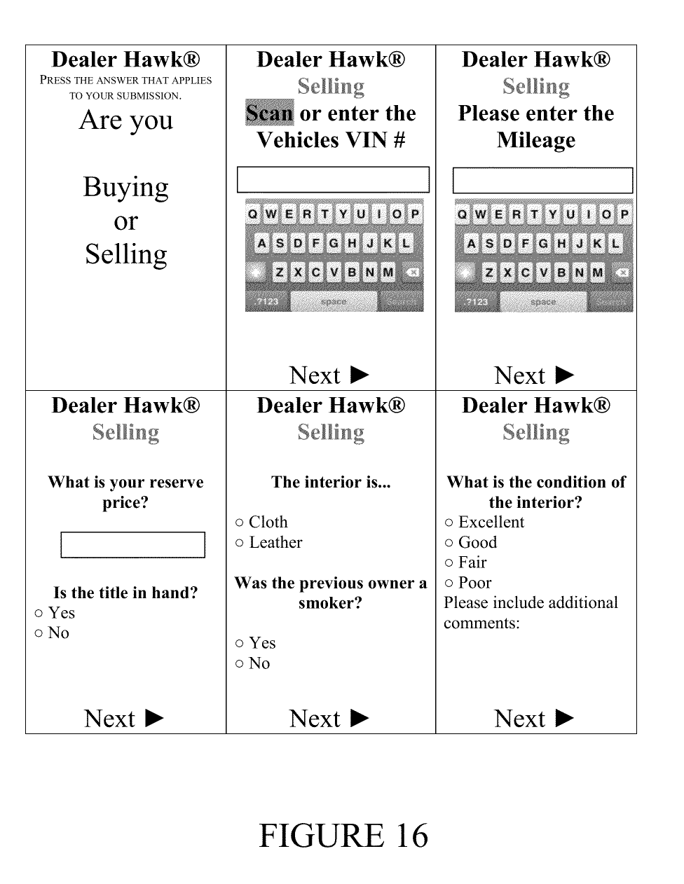

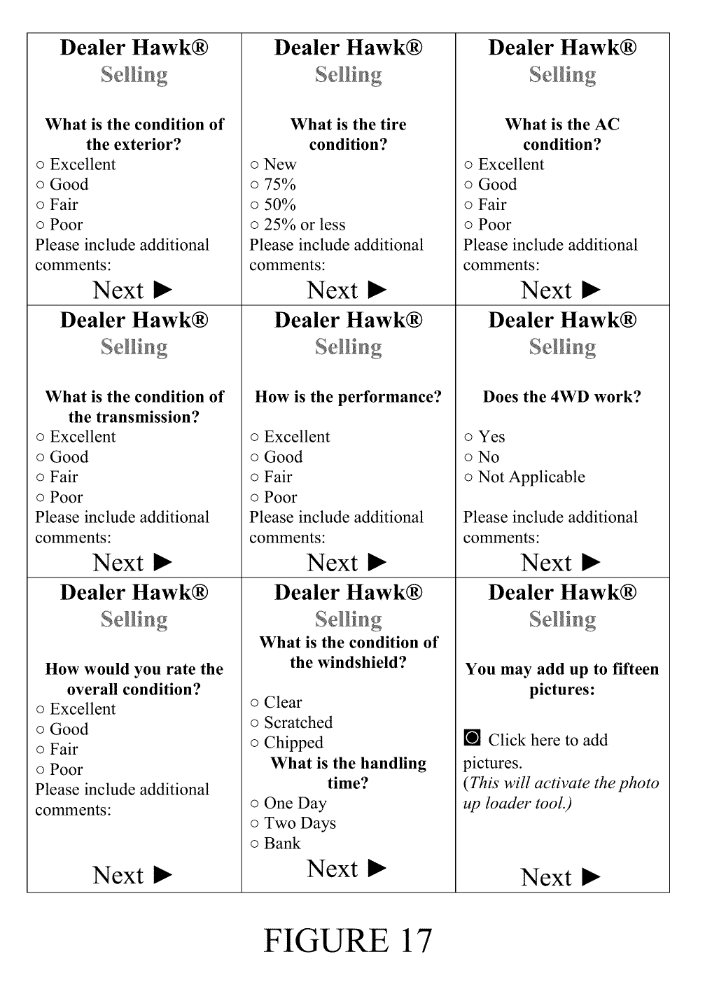

FIG. 16 is an exemplary series of forms such as used in an app embodiment of the application with a small screen. It may be seen that the forms are simplified in order to provide the user with the ability to answer with the small size of a mobile device or smart phone screen. This requires a fair number of forms as shown in FIG. 17, which is a continuation of the forms of FIG. 16, and in fact it is anticipated that these are only a portion of the forms to be used.

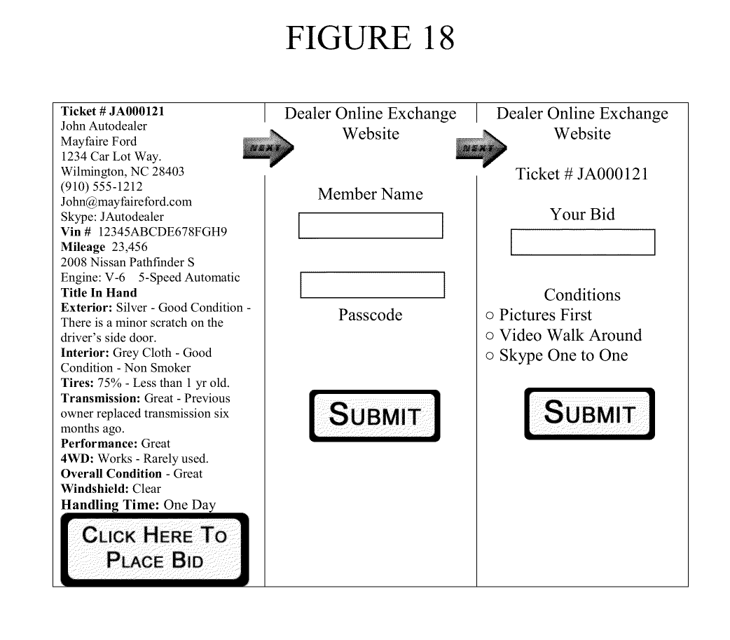

FIG. 18 is an example of a response form on a mobile computing device. Again, it is shrunk and simplified.

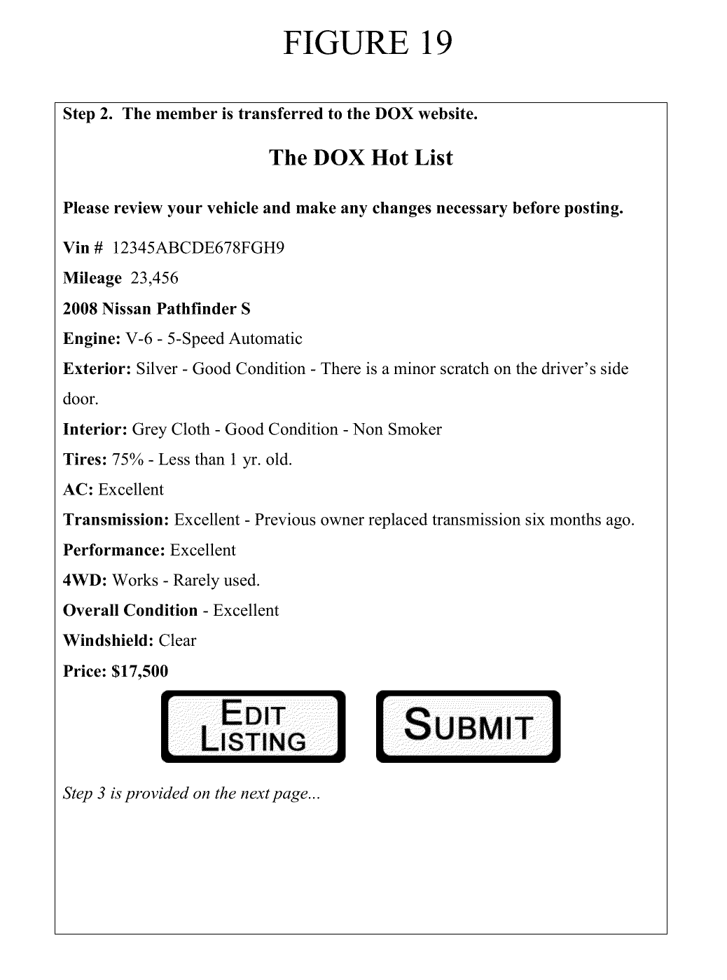

FIG. 19 is an example of a Hot List form for submission, for a system which allows users to manually sign up for the system. However, an automated system for transfer is presently preferred. In this embodiment the user would receive, after 24 hours and timeout from the rapid response system, a message such as the following:

Notice DOX Member

You submitted a 2008 Nissan Pathfinder S, Vin #12345ABCDE678FGH9 using the Dealer Hawk tool, ticket number JA000122. It has been 24 hours since your vehicle has been submitted, it is now eligible to be posted onto the Hot List system for a seven days.

Please select from the following two options.

Thus by this message system the user may more quickly move a vehicle which they still desire to sell or buy. It may be seen that the system in fact comprises a first safety net system for vehicles which do not move immediately. However, a second safety net system is provided in the form of a bulletin board system for car sales.

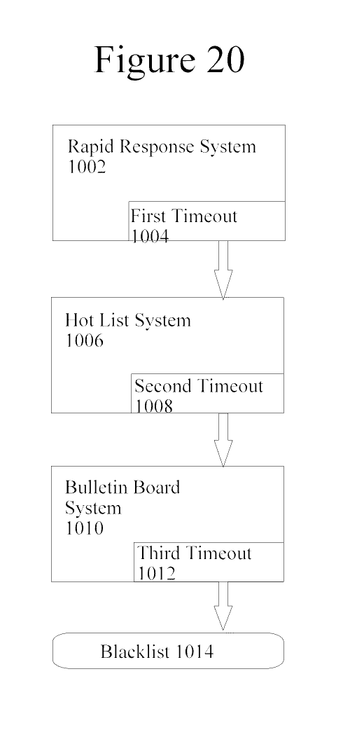

FIG. 20 is an example of the system including the rapid response module, the Hot List module/system, the bulletin board aspect and the respective timeout periods thereof.

Thus the overall system provides tools to its network of auto dealer members that allows them to buy or sell a car quickly through a three step process (the rapid response, the Hot List, the bulletin board) with added exposure for vehicles using multiple tools within the online community. The process for selling/buying utilizes the Dealer Hawk or more generically, “rapid response” tool 1002 for the first 24 hours (1004), then the system will email the member a reminder that she or he can roll the vehicle to the Hot List tool (1006) to be listed for a second timeout period (1008) (preferably seven days), and after the seven days, the system will email the member a reminder that he or she can then roll the vehicle to the Bulletin Board (1010) to be listed for the final 30 days (third timeout period 1012).

It is worth considering the fact that dealers may not instantly respond to the reminder notifications, so an extra increment of time may be needed in between the 24 hours and the 7 days, and a second extra time in between the 7 days and the 30 days. The dealer has a total of 14 days (in case they forget) to roll the vehicle to the Hot List system. After the Hot List system 7 day second timeout period has expired the dealer will have a total of 14 days to roll the vehicle to the Bulletin Board for a final 30 days of the third timeout period. After the final 30 days the member will get an email informing them that the vehicle has been removed from the network. The bulletin board system thus has two 14 day grace periods built into it as well as the 3 timeout periods.

Vehicles submitted to the Bulletin Board 1010 and the Hot List system 1006 can be seen on the social networking area (for example, Carmen's Lounge through a scrolling ticker) as well as on each individual member's personalized Home page area. By this means the dealer is provided with exposure akin to advertising of the vehicle within the system if it is not subject to a rapid response and immediate transaction.

There is also a “blacklist” aspect 1014, advantage and embodiment of the present invention. Once a vehicle has been submitted to network members for buying or selling using the rapid response (Dealer Hawk) tool, the Hot List system and the Bulletin Board, the system will permanently record the VIN number or listing number and it will not be eligible for each tool again until the vehicle has a new owner. The system will need a new member number in conjunction with the VIN number for the vehicle to be eligible once more.

A vehicle is eligible for the Hot List system for only 14 days after its 24 hour rapid response submission period has ended, after that it will only be eligible for the regular Bulletin Board.

It will also be understood that the system allows for different levels of user access, in particular, different roles. It may not be desirable for a normal salesperson to be able to make an actual offer (in response to an offer of interest), so such a function might be reserved for a sales manager's account. The same may be true of selling of vehicles, for example, to prevent sales person's from selling vehicles at a price which is too low. Thus multiple levels of account authority is envisioned, such as: a dedicated “rapid response” expert, sales person, IT person, sales manager, and owner.

The disclosure is provided to allow practice of the invention by those skilled in the art without undue experimentation, including the best mode presently contemplated and the presently preferred embodiment. Nothing in this disclosure is to be taken to limit the scope of the invention, which is susceptible to numerous alterations, equivalents and substitutions without departing from the scope and spirit of the invention. The scope of the invention is to be understood from the appended claims.

I claim:

1. An electronic system for use by a vehicle dealer with a mobile device connected to an electronic network and having an vehicle having details, comprising:
a server having a response module and a networking module programmed therein;
such dealer having available a first module on such mobile device, the first module in turn connecting to the server and to the response module;
such dealer using the first module to provide such details of such car to the response module;
the response module operatively connected to the networking module to narrowcast such details of such vehicle.

2. The electronic system of claim 1, for use by a second dealer having a second mobile device, further comprising:
the narrowcasting of such details comprising transmission of such details by the narrowcasting module to such second dealer by means of such second mobile device.

3. The electronic system of claim 2, further comprising:
a profile module allowing such dealer and such second dealer to individually set up and save to the server respective first and second profiles;
the second profile operative to notify such second dealer of such details only if such details match a selection choice made by such second dealer.

4. The electronic system of claim 3, further comprising:
wherein the first profile operative to notify such second dealer of such details only if such notification matches a selection choice made by such first dealer.

5. The electronic system of claim 1, wherein the response module further comprises:
a member selected from the group consisting of: interactive voice recognition (IVR) systems, an app based check-box and menu system, a server based system, and combinations thereof.

6. An electronic system for facilitating vehicle sales, for use by a first dealer and a second dealer having respective first and second mobile communication devices, the electronic system comprising:
a vehicle having specific characteristics associated therewith, including year of manufacture, manufacturer, mileage and condition;
a membership list including both such first and second dealers;
a server having an offer module, a response module, a tracking module, a rating module, a profile module, a database module and a narrowcast module programmed thereon;
the profile module having a first profile associated with such first dealer and a second profile associated with such second dealer; the profile including for each such dealer a range of characteristics of vehicles in general in which such dealer is interested, including for each such dealer profile at least one year of manufacture and at least one vehicle manufacturer;
the database module containing the characteristics of vehicles in general, including year of manufacture, manufacturer, mileage, condition and optional equipment;
the offer module operative to accept a first communication in the form of an offer of interest from such first dealer, the offer of interest expressing specific characteristics of the vehicle, a first price, and an indication if such first dealer wishes to buy or sell the vehicle; the offer module further operative to access the database module and query such first dealer for answers regarding the characteristics of vehicles in general as found in the database module;
the narrowcast module filtering the offer of interest for characteristics of the vehicle compared to the characteristics of vehicles in general of the second profile of such second dealer, and if the offer of interest passes through the filter, transmitting to such second dealer the specific characteristics of the vehicle;
the response module allowing such second dealer to respond to such offer of interest, the response including a second price for the vehicle; the response module filtering the response for the second price compared to the first price and if the second price meets the first price the response passes through the filter and the response module transmits to such first dealer the response and second price;
the system having a simultaneous offer of interest limit for each such dealer, the offer of interest limit being a maximum number of offers of interest from each such dealer;
the system having a timeout period, the timeout period being the maximum amount of time which an offer of interest is allowed to remain system, after which it is automatically removed from the system;
the offer module further operative to receive all responses and to display them to such first dealer; the first dealer being able to freely choose any response and conclude a transaction for the first vehicle outside of the system;
the tracking module operative to retain offer of interest information about each such dealer in each such dealer's respective profile; the tracking module further operative to display to each such dealer statistics concerning outcomes of offers of interest made through the system;
the ratings module operative to accept and display to all dealers on the membership list ratings of a such first dealer made by such second dealer, such ratings including a rating for the speed of payment and a rating for honesty concerning condition of the vehicle.

7. The electronic system for facilitating the sale of vehicles of claim 6, wherein such first mobile communication device further comprises a mobile computing device having non-volatile memory and selected from the group consisting of: smartphones, tablet computers, and combinations thereof, and wherein the system further comprises:
a client-side app programmed into such mobile computing device non-volatile memory, the client-side app operative to communicate with the server and the server modules.

8. The electronic system for facilitating the sale of vehicles of claim 6, wherein such first mobile communication device further comprises a mobile computing device having non-volatile memory and selected from the group consisting of: laptop computers, desktop computers, and combinations thereof, and wherein the system further comprises:
a client-side computer application programmed into such mobile computing device non-volatile memory, the client side computer application operative to communicate with the server and server modules.

9. The electronic system for facilitating the sale of vehicles of claim 6, wherein such mobile computing device further comprises a telephone; and wherein the offer and response modules further comprise:
one member selected from the group consisting of: an interactive voice response (IVR) system, a script prepared for a live operator, transcription service, and combinations thereof.

10. The electronic system for facilitating the sale of vehicles of claim 7, wherein the offer of interest may comprise one member selected from the group consisting of: interest in concluding a transaction to sell the vehicle, interest in concluding a transaction to buy the vehicle, and combinations thereof.

11. The electronic system for facilitating the sale of vehicles of 10, wherein the response module allows such second dealer to make the response by a method selected from the group consisting of: response through a computer application, response through a mobile device app, response through a text message, response through an email, response by means of an interactive voice response system, transcription service, operator, and combinations thereof; and wherein the response module further comprises: a translation module operative to translate the selected method of the response into a desired response type, the desired response type indicated in the first profile of such first dealer, the desired response type also selected from the group consisting of: response through a computer application, response through a mobile device app, response through a text message, response through an email, response by means of an interactive voice response system, and combinations thereof.

12. The electronic system for facilitating the sale of vehicles of claim 11, wherein the respective first and second profiles of such first and second dealers each further comprises:
a sub-list of such dealers selected from the membership list, the sub-list of such dealers being one member selected from the group consisting of: such dealers to not send offers of interest to nor receive offers of interest from, such dealers to send offers of interest to and receive offers of interest from, and combinations thereof.

13. The electronic system for facilitating the sale of vehicles of claim 12, wherein the simultaneous offer of interest limit is one.

14. The electronic system for facilitating the sale of vehicles of claim 13, wherein the timeout period is 24 hours after which the vehicle is designated as having timed out from the “rapid response” system.

15. The electronic system for facilitating the sale of vehicles of claim 14, further comprising:
a hotlist distributed to the membership list, the hotlist having the vehicle thereon after the vehicle has suffered timeout of an offer of interest for the vehicle from the rapid response system;
the system having a second timeout period, the timeout period being the maximum amount of time which a vehicle is allowed to remain on the hotlist, after which it is automatically removed from the hotlist.

16. The electronic system for facilitating the sale of vehicles of claim 15, wherein the condition of the vehicle further comprises:
a list of conditions of individual parts of the vehicle, the individual parts including portions of the vehicle exterior, portions of the vehicle interior, a vehicle dashboard, and a vehicle engine.

17. A method of facilitating the sale of a vehicle, the method comprising the steps of:
providing a server;
providing a mobile computing device app;
accessing via the app a database module on the server containing the characteristics of vehicles in general, including year of manufacture, manufacturer, mileage, and condition;
entering via the app and by reference to the database module a description of a first vehicle;
narrowcasting the description of the first vehicle to a second mobile computing device app;
responding via such second mobile computing device app to such description of the first vehicle;
compiling all the responses to such description of the first vehicle;
selecting a response and;
concluding a transaction for the first vehicle.

18. The method of facilitating the sale of a vehicle of claim 17, further comprising:
prior to entering a description of the first vehicle, entering a profile, the profile including information about desired vehicle years, costs, manufacturers and makes,
and the step of narrowcasting further comprising only narrowcasting the description of the first vehicle if the description of the first vehicle meets the profile.

19. The method of facilitating the sale of a vehicle of claim 18, further comprising:
entering a first transaction price with the description of the vehicle;
entering a second transaction price with the response;
the step of compiling all responses to such description of the first vehicle further comprising removing the response if the second transaction price does not meet the first transaction price.

20. The electronic system for facilitating the sale of vehicles of claim 15, further comprising:
a bulletin board accessible to the membership list, the bulletin board having the vehicle thereon after the vehicle has suffered timeout of the second timeout period for the vehicle on the hotlist;
the system having a third timeout period, the timeout period being the maximum amount of time which a vehicle is allowed to remain on the bulletin board, after which it is automatically removed from the bulletin board system;
wherein the second timeout period is 7 days and the third timeout period is 30 days.
